(19) United States
(12) Patent Application Publication
(10) Pub. No.: US 2019/0245857 A1
(43) Pub. Date: Aug. 8, 2019

(54) METHOD FOR SECURING ACCESS BY SOFTWARE MODULES

(71) Applicant: Unbound Tech Ltd., Petah Tiqva (IL)

(72) Inventors: Guy Pe'er, Talmey Yechiel (IL); George Wainblat, Tel Mond (IL); Lior Cohen, Rehovot (IL); Alex Gerdov, Rehovot (IL); Oz Mishli, Kfar Saba (IL)

(73) Assignee: Unbound Tech Ltd., Petah Tiqva (IL)

(21) Appl. No.: 15/887,116

(22) Filed: Feb. 2, 2018

(51) Int. Cl. H04L 29/06; H04L 9/08; H04L 9/30; H04L 9/32

(52) U.S. Cl. CPC H04L 63/10; H04L 63/18; H04L 9/085; H04L 9/3263; H04L 9/0894; H04L 9/30; H04L 9/0863

(57) ABSTRACT

The subject matter discloses a method for providing identity to a software module, comprising splitting a secret key using a split multi-party computation (MPC) process between the software module and a security server and storing one share of the secret key in the software module and another share of the secret in the security server, the security server receiving a request from the software module to access a resource, in response to the request, the security server encrypts a message, said encrypted message is obtained by the software module, the software module initiates a decryption multi-party computation (MPC) process to decrypt the message encrypted by the security server using according to the shares of the secret key, the security server receives the decrypted secret and the public key and the security server signs a certificate associated with the requested resource and the software module and sends the certificate to the software module.

### FIELD OF THE INVENTION

The present invention is generally related to data security, more specifically to enabling software modules to access online resources.

### BACKGROUND OF THE INVENTION

Software modules, for example containers are designed to virtualize a single application or service, for example an Apache Tomcat container provides a virtual instance of a java web-server application. Containers create an isolation boundary at the application level rather than at the server level. Unlike virtual machines, they don't need a full operating system to be installed within the container, and they don't need a virtual copy of the host server's hardware. This results in better efficiency as to the number of containers that can be deployed on a server compared to virtual machines. One of the main advantages of containerized software module compared to virtual machines, is that it will always run the same way, regardless of the computing environment, eliminating problems that arise from even subtle differences between the running environments, such as different software, network topology, security policies and storage.

Containers are also very portable—once a container image has been created, it can be deployed to different production servers very easily. From a software lifecycle perspective, containers can be copied to create development, test, integration and live environments very quickly. The short lifetime limits the ability to store a unique identity.

Microservices based on containers form the underlying infrastructure of the ever-growing Cloud-Native eco-system.

Once containers became popular, one of the biggest concerns was how to keep them secure. If the containers are compromised, they can be attacked and the information they access in online resources is also compromised. Thus, there is a technical problem to enable secured access of containers to resources, such as web servers, as such containers are created and deleted in very short processes and typically have very short lifetime.

### SUMMARY OF THE INVENTION

The subject matter discloses a method based on MPC (multi-party computation) for creating strong, cryptographically based identity for various containers, enabling their authentication while accessing discrete resources. The identity may be provided via a pod containing the container, by providing the pod cryptographically based identity via a security server that later allows the pod, or the container, or the application to be authenticated when accessing the discrete online resources. The online resources accessed by the container can be a digital content and computerized services which can be accessed by computerized devices. In some cases, such a digital content and computerized services may comprise, digital content residing in computerized devices, a computer-readable storage medium storing digital content or a set of instructions, computerized device transmitting digital content to other computerized devices, physical or virtual component residing within a computer system, and the like.

It is an object of the subject matter to disclose a method for providing identity to a software module, comprising splitting a secret key using a split multi-party computation (MPC) process between the software module and a security server and storing one share of the secret key in the software module and another share of the secret in the security server; the security server receiving a request from the software module to access a resource; in response to the request, the security server encrypts a message, said encrypted message is obtained by the software module; the software module initiates a decryption multi-party computation (MPC) process to decrypt the message encrypted by the security server using according to the shares of the secret key; the security server receives the decrypted secret and the public key; the security server signs a certificate associated with the requested resource and the software module and sends the certificate to the software module.

In some cases, the secret is encrypted by the security server using a public key accessible to both the security server and the software module. In some cases, the secret is a one-time password generated by the security server.

In some cases, the method further comprises the security server sending the encrypted secret to a repository in communication with the software module and informing the software module that the encrypted secret is stored in the repository, thus providing an out-of-band security layer to the encrypted secret. In some cases, the method further comprises the software module decrypting the secret sent to the repository and sends the decrypted secret to the security server. In some cases, the method further comprises verifying that the software module is allowed to access the requested resource according to a permission storage before the security server encrypts the message.

In some cases, the permission storage is stored in the security server. In some cases, the permission storage is in communication with the security server. In some cases, the software module is a single pod having a plurality of containerized software modules, said pod regulates the method versus the security server. In some cases, the software module is a containerized software module.

It is an object of the subject matter to disclose a system for enabling authentication of a software module, comprising a permission storage configured to store permissions of software modules to resources, a communication module configured to receive requests for permission from software modules and verify the requests' validity with the permission storage, an MPC module configured to execute a first MPC process with the software module for creating a split a secret key and a second MPC process with the software module for decrypting a message, a signing module configured to sign a certificate in response to the second MPC process performed by the MPC module, said communication module is further configured to send the signed certificate to the software module.

In some cases, the system further comprises a key share storage configured to store key shares of multiple software modules requesting access from the security server.

### BRIEF DESCRIPTION OF THE FIGURES

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 shows a computerized environment for providing a cryptographically based identity to containers, according to exemplary embodiments of the present invention;

FIG. 2A shows a computerized environment for providing a cryptographically based identity to containers arranged in pods, according to exemplary embodiments of the present invention;

FIG. 2B shows a computerized environment for providing a cryptographically based identity to containers arranged in pods using an auxiliary security repository, according to exemplary embodiments of the present invention;

FIG. 3 shows a security server for providing a cryptographically based identity to containers, according to exemplary embodiments of the present invention; and,

FIG. 4 shows a method for providing a cryptographically based identity to containers, according to exemplary embodiments of the present invention.

### DETAILED DESCRIPTION

The present invention discloses a method for providing a cryptographically based identity to a software module having a memory, processing module and communication capabilities. Such software module may reside on a personal device, for example an application operating on a smartphone, tablet, laptop, server and the like. A software module may reside on an online server, for example a virtual machine (VM). For simplicity, and due to the short life cycle of containerized software modules, most of the examples below refer to containerized software modules, also defined below as container for simplicity. The container according to the present invention is defined as an operating system feature in which the kernel allows the existence of multiple isolated user-space instances, wherein such an isolated user-space instance is defined herein as a container. The container technology may be, but unlimited to a Docker, LXC, rkt, BSD jails, LXD, etc. An authentication scheme is required in cases the container requests access to an online resource. Such access may be for information stored within a database or files stored in the online resource. In case, an online resource contains confidential information access to the container can be only enabled by authenticating the container for a permitted identity to an authenticated and eligible identity. For example, an identity can be an eligible identity by receiving a digital certificate issued by a security server which controls access to the resource. The authenticity of the eligible identity can be verified with the digital certificate, for instance a container may utilize a digital certificate issued by a security server which controls access to the online resource. In some cases, such a security server can be a certificate authority (CA) designed to issue and deploy digital certificates. In some other cases, the security server can be a computerized device designed to deploy digital certificates. The security server may also be designed to execute a Multi-Party Computation (MPC) protocol when deploying a cryptographically based identity to a container for accessing an online resource. In such cases, the security server can split a secret associated with the cryptographically based identity into two shares, for example an encryption key can be secret, and wherein one share can be held or stored by the container and another share can be held or stored by the security server. In some exemplary cases, the security server may cooperate with a group of containers deployed together on one single computerized host, also known as pod. The security server generates a security certificate upon receiving an indication which the container authenticity is verified, by passing cryptographically verifiable test. The security server is also designed to issue a certificate for a specific container and a specific online resource, upon a specific access needs. In some cases, a single certificate may enable the container to access multiple resources.

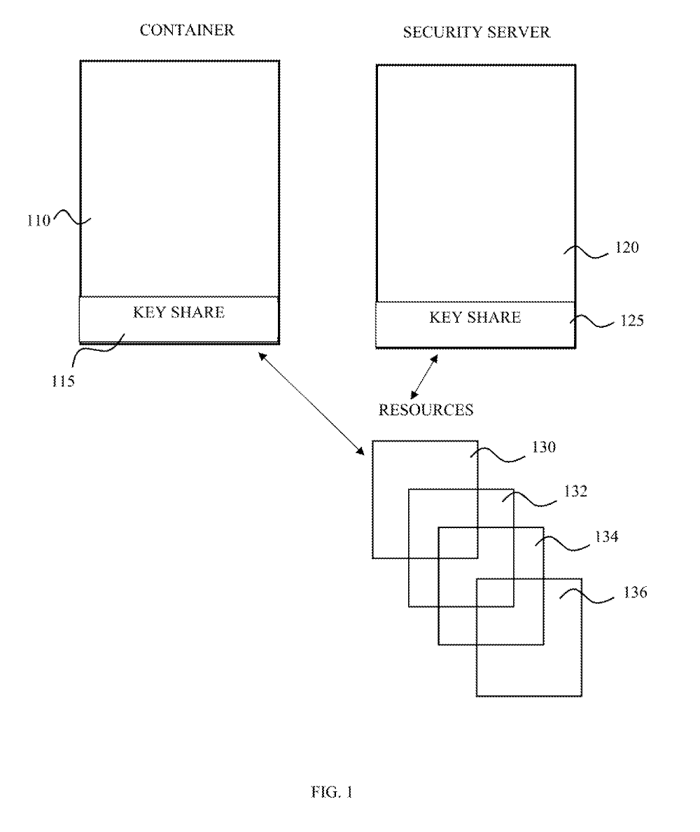

FIG. 1 shows a computerized environment for providing identity to containers, according to exemplary embodiments of the present invention. The computerized environment shows a container 110 communicating with a security server 120 in order to receive a certificate from the security server 120 to access the resource. The container 110 and the security server 120 can exchange information over a communication network, for example the internet, WAN, LAN and the like. Thus, both the container 110 and the security server 120 comprise communication modules. Additionally, both the container 110 and the security server 120 are characterized with the capability of storing a share, or shares, of a secret. The shares of the secret are divided and stored, a first share 115 by the container 110 and a second share 125 by the security server 120. The security server 120 comprises a share database, in which multiple shares are stored, each share with an identifier of the corresponding container.

The security server 120 also comprises an MPC module (not shown) configured to execute the MPC process resulting in one share of the secret stored in the container 110 and the other share stored in the security server 120. The two shares are required to decrypt and/or encrypt message, thus verifying by the security server 120 that the authenticity of the container 110 is verified and as a result of the verified authenticity a certificate can be sent,.

The security server 120 controls access to multiple resources 130, 132, 134, and 136. In some cases, the online resources may be storage devices located on a communication network, and the container requests access to the data in the storage devices. In some other cases, the container 110 requests permission to activate, deactivate or control different types of files stored in the resources 130, 132, 134, and 136. The container 110 may adjust, reconfigure or amend information or rules stored in the resources 130, 132, 134, and 136, for example according to instructions stored in a memory unit of the container 110.

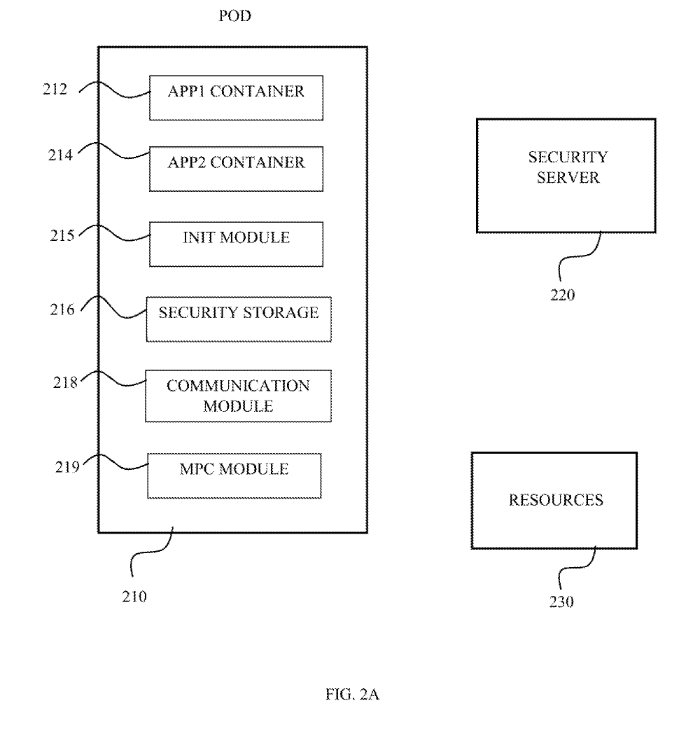

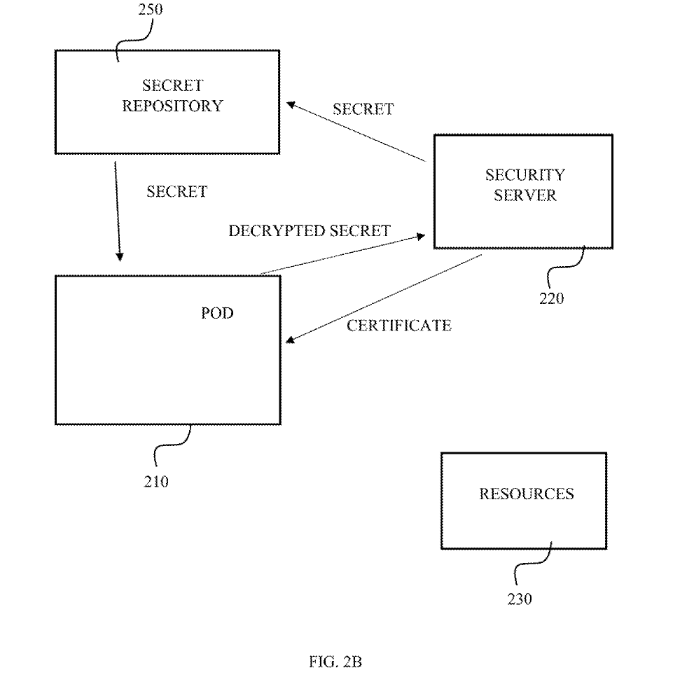

FIG. 2A shows a computerized environment for providing identity to containers arranged in pods, according to exemplary embodiments of the present invention. In some exemplary embodiments, containers may be arranged in Pods. A pod 210 can be co-located and co-scheduled, and operate in a shared computerized host. In some other cases, containers may operate independently, using independent processing units, memory and communication. In some cases, wherein the pod runs as a single container, it may be equivalent to an independent container operating with the security server 220. The pod 210 cooperates with the security server 220 to result in obtaining a certificate for a container included in the pod 210. A single pod may run multiple authentication procedures for multiple different containers included in the pod 210.

The pod 210 comprises one or more containers 212, 214. The containers 212, 214 are required to access the resource 230, or multiple resources, as part of the operation of the containers 212, 214. The pod 210 also comprises an initialization module 215 configured to control the initialization of the identification process of a container in the pod. The initialization module 215 is configured to generate an identifier of the new container. The initialization module 215 is further configured to verify execution of a distribution MPC process. The output of the distribution MPC process is that one share of a secret is stored in the pod 210 and another share of the secret is stored in the security server 220. The secret may be an encryption key. The initialization module 215 can be further configured to verify creation of a public key for the pod 210 at the shared volume of the pod 210. The public key and the pod's name may be sent to the security server.

The pod 210 further comprises a security storage 216, configured to store secret shares of the multiple containers included in the pod 210. The security storage 216 may comprise a volatile or non-volatile memory. The security storage 216 may also store the public keys and certificates issued by the security server 220. The pod 210 further comprises a communication module 218 configured to exchange information to and from the security server 220, and with the resources. The pod 210 may also comprise an MPC module 219, configured to participate in an MPC process computed by exchanging information between the pod 210 and the server 220, without revealing the shares stored in one entity to the other entity.

FIG. 2B shows a computerized environment for providing identity to containers arranged in pods using an auxiliary security repository, according to exemplary embodiments of the present invention. The security repository 250 communicates with both the server 220 and the pod 210. The security repository 250 is configured to enable an out-of-band path, external to the containers orchestration and management system, between the server 220 and the pod 210. In the embodiment using out-of-band path, the server sends an encrypted message to the security repository 250. The pod 210 accesses the security repository 250, receives the encrypted secret and decrypts the secret using an MPC process with the server 220. In some other cases, the server 220 may send the encrypted message directly to the pod 210 for decryption. After the message is decrypted and sent to the server 220, the server issues a certificate to the pod 210, which enables a specific container access to the requested resource.

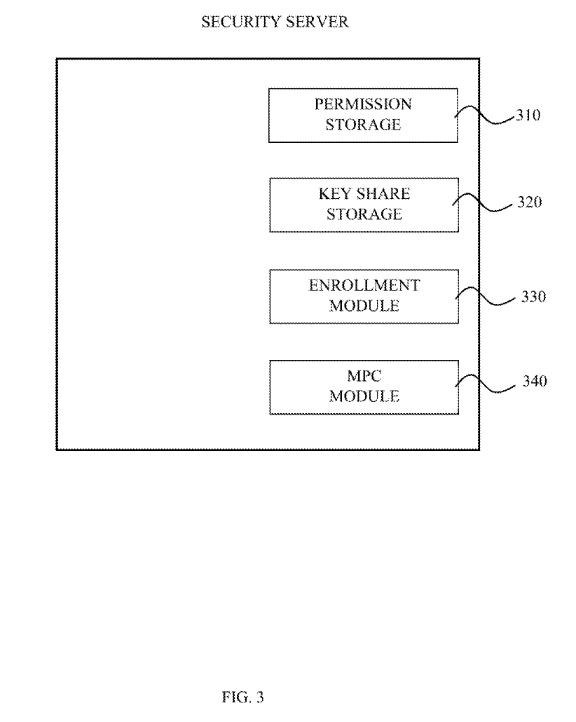

FIG. 3 shows a security server for providing identity to containers, according to exemplary embodiments of the present invention. The security server comprises an MPC module 340 configured to execute MPC processes with an MPC module 219 of the pod 210. The MPC modules 340 and 219 divide the secret between the server and the pod, and also decrypt the message encrypted by the security server.

The security server also comprises a permission storage 310, configured to store the definition of the relationship between containers and resources, wherein the definition may comprise which container is eligible to access a resource or resources. The security server also comprises an enrollment module 330 configured to manage the enrollment process on the server side, and communicate with the pod's communication module. The enrollment module 330 is connected to the permission storage 310, for example to request certificate or verify that the container requested access to the online resource already assigned to the container, or allowed to be accessed by the container. The permission storage 310 keeps an authorization table associating the pods' identity and the resources to which the pods are eligible to access.

The security server also comprises a secret storage 320 configured to store the secret share resulting from the dividing MPC process.

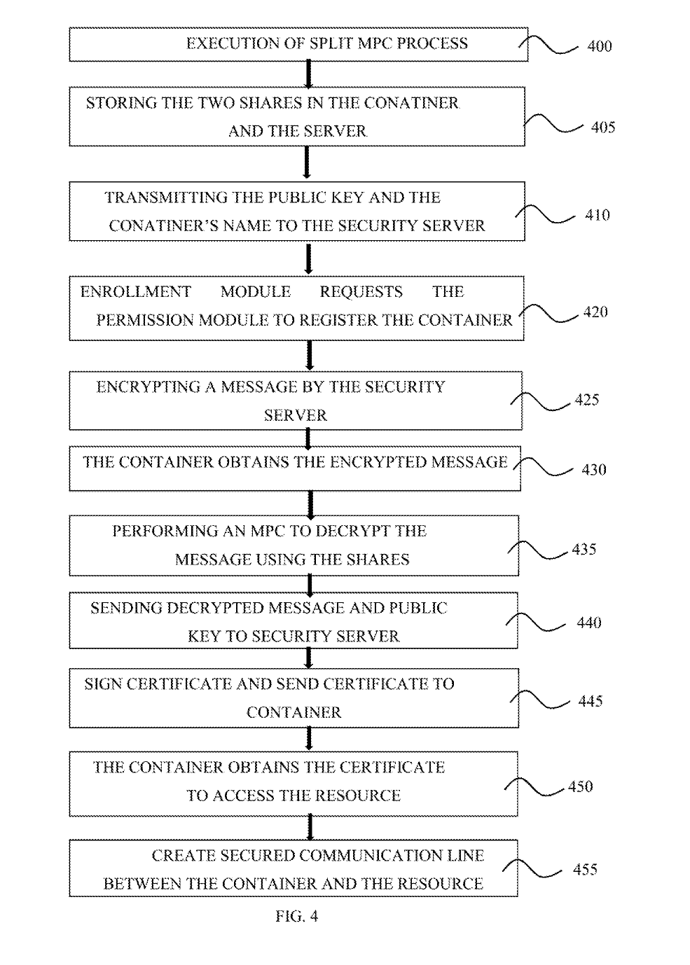

FIG. 4 shows a method for providing identity to containers, according to exemplary embodiments of the present invention.

Step 400 discloses executing a split MPC process. The split MPC process is performed between the container and the security server, creating two shares of the secret, in each of the locations. In some exemplary cases, at least a portion of the method is performed between the security server and a pod containing multiple containers. The output of the MPC process is that two shares are stored in the two entities that executed the MPC process—the container and the security server, as shown in step 405. None of the entities has access to the share stored in the other entity during the entire process disclosed herein. The full secret cannot be derived from obtaining each of the two splits alone.

Step 410 discloses sending the public key and the container's name to the security server. Such transmission is performed using a communication module of the container. The communication between the security server and the container may be via an internet gateway, LAN, WAN, cellular network, or any technique, network or protocol desired by a person skilled in the art.

Step 420 discloses the enrollment module requests the permission module to register the container. Such request contains an identifier of the container and an identifier of the resource to be accessed by the container. First, the permission module verifies that the container having the same identifier allowing to access the specific online resource. For example, the permission module of the security server may be responsible to 5,000 resources, and has 100,000 containers accessing the 5,000 resources. The permission of the containers to the resources may be inputted manually using a user interface of the security server or via a device communicating with the security server. Access to resources may change over time, for example periodically or in response to an event.

In case the container is eligible to access the online resource, the security server authenticates the resource using the actions detailed below. In step 425, the security server encrypts a message by utilizing the public key of the container. Such encryption may be performed by the permission module of the security server, or by another module of the server. The security server may store multiple public keys, wherein the multiple public keys are associated with a specific container. When container requests permissions to access to an online resource, the message is encrypted with the public key associated with the container which sent the request for permissions. In some exemplary cases, the message encrypted with the public key can be a one-time password (OTP). The message may be any message desired by a person skilled in the art. In some cases, the message may be a random message.

Step 430 discloses the pod obtaining the encrypted message. In some cases, the security server transmits the encrypted message directly to the container. In some other cases, the encrypted message is sent to a secret repository, communicably coupled to the security server and to the container. Then, the container accesses the encrypted message, for example by copying the encrypted message to a memory unit in the container. Sending the encrypted message to a third party, for example the secret repository, enables out-of-band protection of the message.

Step 435 discloses performing a decryption MPC process to decrypt the encrypted message using the shares stored in the pod and the server. The decryption MPC process is initiated by the container, requesting the security server to activate the container's access to the resource. The security server and the container cooperate in order to decrypt the message. During the decryption MPC process, both the security server and the container cannot be granted with access to the key share stored in the other entity, nor is the entire key ever combined in the memory, in the disk or on the network. The decryption MPC process comprises exchanging information between the security server and the container.

Step 440 discloses the container sending decrypted message and public key to the security server. Step 445 discloses the security server signing a certificate and sending certificate to container. The certificate may enable access of the container to a single resource, or to multiple resources. Step 450 discloses the container obtaining the signed certificate received from the security server. The signed certificate enables the container to access the resource. Next, Step 455 discloses the container creating a secured communication line, for example TLS or SSL with the resource. The secured communication line is configured to prevent undesired leakage of the information stored in the resource, as it may contain sensitive information.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A method for providing identity to a software module, comprising:
splitting a secret key using a split multi-party computation (MPC) process between the software module and a security server and storing one share of the secret key in the software module and another share of the secret in the security server;
the security server receiving a request from the software module to access a resource;
in response to the request, the security server encrypts a message, said encrypted message is obtained by the software module;
the software module initiates a decryption multi-party computation (MPC) process to decrypt the message encrypted by the security server using according to the shares of the secret key;
the security server receives the decrypted secret and the public key;
the security server signs a certificate associated with the requested resource and the software module and sends the certificate to the software module.

2. The method of claim 1, wherein the secret is encrypted by the security server using a public key accessible to both the security server and the software module.

3. The method of claim 1, wherein the secret is a one-time password generated by the security server.

4. The method of claim 1, further comprises the security server sending the encrypted secret to a repository in communication with the software module and informing the software module that the encrypted secret is stored in the repository, thus providing an our-of-band security layer to the encrypted secret.

5. The method of claim 4, further comprises the software module decrypting the secret sent to the repository and sends the decrypted secret to the security server.

6. The method of claim 5, further comprises verifying that the software module is allowed to access the requested resource according to a permission storage before the security server encrypts the message.

7. The method of claim 6, wherein the permission storage is stored in the security server.

8. The method of claim 6, wherein the permission storage is in communication with the security server.

9. The method of claim 1, wherein the software module is a single pod having a plurality of containerized software modules, said pod regulates the method versus the security server.

10. The method of claim 1, wherein the software module is a containerized software module.

11. A system for enabling authentication of a software module, comprising:
a permission storage configured to store permissions of software modules to resources;
a communication module configured to receive requests for permission from software modules and verify the requests' validity with the permission storage;
an MPC module configured to execute a first MPC process with the software module for creating a split a secret key and a second MPC process with the software module for decrypting a message;
a signing module configured to sign a certificate in response to the second MPC process performed by the MPC module, said communication module is further configured to send the signed certificate to the software module.

12. The system of claim 11, further comprises a key share storage configured to store key shares of multiple software modules requesting access from the security server.
